(19) United States
(12) Patent Application Publication
(10) Pub. No.: US 2011/0074777 A1
(43) Pub. Date: Mar. 31, 2011

(54) Method For Displaying Intersections And Expansions of Three Dimensional Volumes

(76) Inventors: Kenneth M. Lima, Jamestown, RI (US); Gregory M. Neilson, Mesa, AR (US); Todd P. Drury, Bristol, RI (US); Gary L. Graf, Phoenix, AZ (US)

(21) Appl. No.: 12/566,852

(22) Filed: Sep. 25, 2009

(51) Int. Cl. G06K 9/46; G06T 17/10

(52) U.S. Cl. 345/420; 382/195

(57) ABSTRACT

A method is provided for displaying intersections and expansions of three dimensional volumes comprising the steps of representing a volume in a binary-enumerated three dimensional array format wherein data points outside the volume are set to a first value and data points inside the at least one volume are set to a second value. Surface data points of the volume are determined by comparing each data point with neighboring data points and selecting data points which have neighboring data points which differ in value as the surface data points. The surface data points are classified wherein the classifications comprise at least one of corners bent in three dimensions, edges bent in two directions, flat surfaces, arcs, and rounded surfaces with the classifications stored and the surface points displayed. The method can further comprise processing an intersection between two volumes wherein each volume is represented in the binary-enumerated three-dimensional array format.

### STATEMENT OF GOVERNMENT INTEREST

The invention described herein may be manufactured and used by or for the Government of the United States of America for governmental purposes without the payment of any royalties thereon or therefore.

### CROSS REFERENCE TO OTHER PATENT APPLICATIONS

None.

### BACKGROUND OF THE INVENTION

1. Field of the Invention

The present invention relates generally to displaying three dimensional volumes and, more particularly, to faster processing methods for expanding and/or determining the intersections of three dimensional volumes.

2. Description of the Prior Art

Methods for expansions and intersections of volumes may be utilized in various applications. For example, expansions and/or intersections of three dimensional volumes may be utilized for visually evaluating the position of naval contacts at sea in real time. Naval contacts of vessels of interest are often intermittent and therefore the actual real time position of the contact may be uncertain.

Generally, the contact position continually changes with time. When the actual position of a contact is unknown, it may be desirable to obtain an estimate of the contact's position within a desired probability of accuracy. For this purpose, estimates of a contact's actual position may be made using the initial position and probability or uncertainty estimates (containment areas), expanded for elapsed time, and intersected with the most current positional uncertainty estimate. For such estimates, continual refinement of the containment areas would greatly aid in the deployment of naval forces.

However, prior art methods for computing these processes have been found to be too slow in rapidly evolving tactical situations. Current numerical methods, several of which are discussed hereinafter, are especially time-consuming for an arbitrarily shaped object.

For rapidly evolving tactical situations, it is important to quickly determine and/or visualize the limiting boundary to which the object may have moved over the elapsed time or the limiting boundary which represents the maximum extent of object growth—given changes in environmental conditions.

While faster processing of expansions and/or intersections of three dimensional volumes is useful for addressing naval tactical problems, it is believed that faster processing techniques may also be useful outside of the naval arena. More generally, data sources representing real world objects may represent the position or shape of an object at one point in time and/or may represent an object held under constraints by a certain set of environmental conditions. In typical circumstances, the uncertainty of position or shape of the object is altered as time advances or as environmental conditions change.

As another specific example, it is believed that processing expansions and/or intersections of volumes may be useful for visual simulations of expanding clouds of toxic gas. As another example, processing expansions and/or intersections of volumes may be applied to the intersection of models in a computer game. Accordingly, it is believed that a faster processing means for three dimensional volumes can be useful to many applications in science and technology.

The following United States patents describe various prior art systems that may be related to the above and/or other methods for expanding and/or intersecting volumes:

United States Patent Publication Serial No. 2005/0052452, by A. Baumberg (published Mar. 10, 2005) discloses a 3D computer model of an object which is generated by processing a preliminary 3D computer model and the silhouette of the object in images recorded at different positions and orientations. The processing comprises calculating smoothing parameters to smooth the 3D computer model in dependence upon a geometric property of different parts of the silhouettes, such as a curvature or width of the silhouette parts, calculating displacements to move surface points in the 3D computer model to positions closer to the projection of the silhouette boundaries in 3D space, and moving surface points in the 3D computer model in accordance with the smoothing parameters and displacements. The 3D computer model is smoothed to different extents in different areas, resulting in a 3D surface in which unwanted artifacts are smoothed out but high curvature features and thin features representing features present on the subject object are not over-smoothed.

United States Patent Publication 2002/0190982, to Kotcheff et al. (published Dec. 19, 2002) discloses a 3D computer model of an object which is generated by calculating the intersections of polyhedra. Each polyhedron defines a volume of 3D space containing at least part of the object. The 3D points of intersection of the planar faces of the polyhedra are calculated and each point is labeled with the planar faces which meet thereat. The points are connected to form a polygon mesh using the labels to determine which points should be connected together. In calculating the points, a volume containing the object is subdivided into parts. Each part is tested against the polyhedra and then discarded, subdivided further, or the point of intersection of planar faces within the volume part is calculated. A volume part is discarded if it is outside at least one polyhedron. The volume part is subdivided into further parts if it is intersected by more than a predetermined number of polyhedra faces.

United States Patent Publication Serial No. 2005/0122324, to K. Venkataraman (published Jun. 9, 2005) discloses a method wherein a slice plane, oriented parallel to a viewing plane, is passed through a cuboidal dataset at regular intervals. The intersection of the slice plane with the cuboidal volume dataset results in primitives (quads, triangles, etc. depending on the angle and position of the intersection) whose vertices have position coordinates and 3D-texture coordinates (r, s, t). The resulting primitives are rasterized using, for example, a traditional 3D graphics pipeline wherein the 3D-texture coordinates are interpolated across the scanlines producing 3D-texture coordinates for each fragment. The resulting 3D-texture coordinates for each fragment are stored in a 2D-texture storage area. These 2D-textures are called density-textures. By preprocessing the cuboidal dataset, the rendering process becomes a compositing process. A rendering process is comprised of looking-up, for each densel in the texture, the corresponding color and opacity values in the current lookup-table. A user-specified compositing function is used to blend the values with those in the framebuffer to arrive at the final result. The final result (i.e., the values in the framebuffer) is displayed.

United States Patent Publication Serial No. 2006/0017724, to C. Tsao (published Jan. 26, 2006) discloses representing a desired brightness level in the geometric primitive as a fraction of the maximum number of display elements, and representing the maximum brightness level, that can be placed in it. There are two approaches to achieve this control: Point-based Rendering and Intersection-based Rendering.

In Point-based Rendering, a geometric primitive is converted into a representation of sampling points and then the sampling points are rendered. In Intersection-based Rendering, the intersections of a geometric primitive with the frame slices are rendered. The basic procedure to render a texture-mapped surface is to divide the surface into a number of regions, each region having a different intensity range, and then render each region with a different density of display elements to represent different brightness level. The procedure of rendering a 3D volume with gray scale distribution is similar.

United States Patent Publication Serial No. 2006/0146048, to Wright et al. (published. Jul. 6, 2006) discloses a system and method for generating a region in an air-space environment for presentation in a visual representation. The region is configured for positioning in an aerial domain of the environment coupled to an adjacent reference domain of the environment. The system comprises a control element generator configured for providing a plurality of control elements of the region, wherein the plurality of control elements are distributed in the air-space environment such that each of the plurality of control elements is coupled to a respective coordinate associated with the reference domain the system and method also have a link generator configured for providing a plurality of link elements of the region for linking each of the control elements to one another to define a plurality of bounding surfaces of the region, and an edit module for adjusting at least one presentation property of the region.

United States Patent Application Serial No. 2007/0195087 to Acosta et al. (published Aug. 23, 2007) discloses a system and method for analyzing and imaging three dimensional volume data sets. In one embodiment, a ribbon section is produced which may include a plurality of planes projected from a polyline. The polyline may include one or more line segments preferably formed within a plane. The projected planes intersect the three dimensional volume data set and the data located at the intersection may be selectively viewed. The polyline may be edited or varied by editing or varying the control points which define the polyline. In another embodiment, a method is provided for tracking a physical phenomena represented within the three dimensional volume data set. A plurality of planes may be successively displayed in the three dimensional volume data set from which points are digitized related to the structure of interest to create a spline curve on each plane. The area between the spline curves is interpolated to produce a surface representative of the structure of interest, which may for example be a fault plane described by the three dimensional volume data set. In this manner, the user can more easily and effectively visualize and interpret the features and physical parameters that are inherent in the three dimensional volume data set.

U.S. Pat. No. 5,201,035, to Stytz et al. (issued Apr. 6, 1993) discloses a dynamic algorithm selection for volume rendering, isocontour and body extraction within a multiple-instruction, multiple-data multiprocessor. This is a methodology which reduces the time required to render a volume with extracted isocontours and inserted cutting plane and perform an arbitrary rotation within a three dimensional volume. The volume is first partitioned among the processors of a multiple-instruction, multiple-data (MIMD) multiprocessor computer. As the user indicates the isocontour to be extracted, rotation, and cutting plane to be inserted into the image space volume, each processor independently selects the optimum algorithm for rendering the volume using the indicated display parameters on its local data set. If the processor is fully behind the cutting plane, a front-to-back (FTB) volume rendering algorithm is used. If the cutting plane lies behind the cutover point, then a back-to-front (BTF) volume rendering algorithm is used, otherwise the FTB volume rendering algorithm is used.

U.S. Pat. No. 5,454,068, to Ramanujam (issued Sep. 26, 1995) discloses a 3D scientific visualization system for viewing models composed of polyhedra or other elements having vertices at which analysis results (e.g., temperature or pressure) are defined. The model is viewed either in a cutting plane or as a contour surface in which a given result assumes a specified value. Polygons making up an intersection surface formed by the intersection of the cutting plane or contour surface with the polyhedra forming the model are generated and passed to a polygon processor for rendering and display on a raster-scan device. A series of intersection surfaces are generated for display by varying either the position of the cutting plane along its normal or the value that the result assumes on the contour surface. The testing of elements for possible intersection by the cutting plane or contour surface is speeded up by presorting the elements into zones, based upon either the position of each element along the cutting plane normal or the value of the result over the vertices of the element, and testing only elements within certain zones for intersection with the plane or surface. Intersection calculations for edges shared by multiple elements are minimized by maintaining a global list of edges and flagging those edges whose intersection point with the cutting plane or contour surface has been calculated for any element of the model. The outer surfaces are identified for viewing in an alternative mode of operation by counting the elements sharing a given face of the model and flagging as outer faces those faces associated with only a single element.

U.S. Pat. No. 6,765,570, to Cheung et al. (issued Jul. 20, 2004) discloses a system and method for analyzing and imaging three dimensional volume data sets using a three dimensional sampling probe. A number of sampling probes can be created, shaped, and moved interactively by the user within the whole three dimensional volume data set. As the sampling probe changes shape, size, or location in response to user input, the image is re-drawn at a rate sufficiently fast to be perceived as real-time by the user. In this manner, the user can visualize and interpret the features and physical parameters that are inherent in the three dimensional volume data set.

U.S. Pat. No. 7,133,041, to Kaufman et al., (issued Nov. 7, 2006) discloses an apparatus and method for real-time volume processing and universal three dimensional rendering. The apparatus includes a plurality of three dimensional (3D) memory units; at least one pixel bus for providing global horizontal communication; a plurality of rendering pipelines; at least one geometry bus; and a control unit. The apparatus includes a block processor having a circular ray integration pipeline for processing voxel data and ray data. Rays are generally processed in image order thus permitting great flexibility (e.g., perspective projection, global illumination). The block processor includes a splatting unit and a scattering unit. A method for casting shadows and performing global illumination in relation to light sources includes sweeping a two dimensional array of rays through the volume can also be implemented with the apparatus. A method for approximating a perspective projection includes using parallel projection.

The above cited prior art does not disclose a method which provides sufficient speeds of the process of expanding models of three dimensional volumes and/or computing the intersection region between different three dimensional volume models for the applications discussed hereinbefore. A long felt need exists for the solutions to the above described and/or related problems. Consequently, those skilled in the art will appreciate the present invention that addresses the above and other problems.

### SUMMARY OF THE INVENTION

It therefore a general purpose and primary object of the present invention to provide an improved method for processing and displaying expansion and intersection of volumes.

It is a further object of the present invention to provide a faster method for displaying naval contacts with regions of uncertainty.

It is a still further object of the present invention to provide a method for displaying volumes of gas that are injected into the atmosphere.

In order to attain the objects described above, the present invention provides a method for displaying intersections and expansions of three dimensional volumes. The three dimensional volumes represent physical phenomena which may vary in shape as time progresses. For example, a volume might represent a region inside of which there is a selected probability that a contact exists. The volume shape may change over time based on information about the contact initial heading, speed, and the like. In another embodiment, a volume might represent a region of gas which expands over time. The volume shape may change over time due to wind velocity, entropy, relative weight of the gas, and the like.

The method may comprise steps such as representing at least one volume in a binary-enumerated three dimensional array format wherein all data points outside the volume may be set to a first value and all data points inside the volume may be set to a second value. For example, the first value may be zero and the second value may be greater than zero.

The method may further comprise determining surface data points of the volume by comparing each data point with neighboring data points. The program may then select data points which have neighboring data points which differ in value as the surface data points for classification.

In one embodiment, the surface data point classifications can comprise classifications such as but not limited to, for example, corners bent in three dimensions, edges bent in two directions, flat surfaces, arcs, vectors, equations, and/or rounded surfaces. The method may further comprise making and storing lists of the classifications of the surface points. The lists may be utilized for more quickly displaying the volume surfaces.

The method may further comprise processing an intersection between at least two volumes wherein each volume could be represented in the binary-enumerated three dimensional array format. This may comprise steps such as creating a third value for intersecting data points which have the second value at the same location in a coordinate system. In other words, two volumes may have a “one” for data points at the same location in a coordinate system, which is used to describe the binary enumerated array. Then the value at that location is set to a third value, e.g., two. The same would be done for all other data points which have a “one” at the same coordinate location.

A new intersection volume may then be created by setting data points which have the first value or the second value to the first value and setting data points with the third value to the second value whereby at least one intersection volume is formed in the binary-enumerated three dimensional array format.

Additional steps may comprise classifying the surface data points with classifications wherein the classifications comprise at least one of corners bent in three dimensions, edges bent in two directions, flat surfaces, arcs, and rounded surfaces. The method may then comprise making and storing lists of the classifications of the surface points for faster displays of the volume surfaces.

The method may comprise expanding a volume by applying a respective expansion volume or template to each selected surface data point of a volume where expansion is to occur. This may involve setting data points, which are inside both the expansion volume and the volume to be expanded, to the second value. In this way, an expanded volume is formed in the binary-enumerated three dimensional array format.

The method may involve an isotropic expansion which may be made by applying a spherical volume to a plurality of surface data points of the volume to be expanded. The method may also involve a non-isotropic expansion which is made by applying a non-spherical volume to a plurality of surface data points. Portions of a volume may be expanded while other portions of the volume are not affected. The volume could even be expanded at a single surface data point.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1A depicts a schematic disclosing one side of a binary enumerated volume wherein elements within the volume are represented by a first value and elements outside of the volume are represented by a second value in accordance with one embodiment of the present invention;

FIG. 1B depicts a schematic disclosing a binary enumerated volume similar to that of FIG. 1A with but with less definition of the volume due to less density of data points in accordance with one embodiment of the present invention;

FIG. 2 depicts a schematic disclosing a representation of a surface of a cubical volume wherein surface points of the volume have been classified as corners which bend in three dimensions, edges that bend in two dimensions, and flat surface areas in accordance with a possible embodiment of the present invention;

FIG. 3A depicts a schematic showing one side of two volumes which intersect in accordance with one embodiment of the present invention;

FIG. 3B depicts a schematic of the resulting intersection volumes of FIG. 3A in binary-enumerated format in accordance with an possible embodiment of the present invention;

FIG. 4 is an elevational view schematic which shows an outline of isotropic expansion around either a single point or a point on the surface of a volume in accordance with one embodiment of the present invention; and

FIG. 5 depicts a schematic which shows one side of a volume with an isotropic expansion around points which lay on a curved surface of a volume wherein an outline of the expansion is shown with respect to several of the surface points in accordance with one embodiment of the present invention.

### DETAILED DESCRIPTION OF THE INVENTION

The present invention comprises three basic steps. First, the data representing an original volume is converted into a format compatible with the method or software associated with the method of the present invention. The original volume may be initially developed or described by means discussed hereinbefore in the background section and as such known to those ordinarily skilled in the art.

In the case of naval contacts, the original contact may be represented by a point which is then expanded in selected directions representing the volume in which the contact is expected to be found based on the type of vessel, the original heading, the original and maximum speeds, and other such information. The shape of this expanded volume may be digitized and the information may be graphically presented on a screen as a volume.

An original volume may be described mathematically, photographically digitized, or the like. Thus, many means may be utilized to obtain the original volume in a digitized format. In one embodiment of the invention, the original volume is then converted to a desired format, which may be a three dimensional binary-enumerated array format. Features of a binary-enumerated array format in accordance with the present invention are discussed hereinafter.

Second, once in the desired binary-enumerated array format, the data may be either expanded and/or intersected as desired. The present invention is largely concentrated in this second step, where speed of processing is desired.

The resultant volume is output that is in a format suitable for display or further processing. For example, a binary-enumerated array format may be utilized to turn pixels on or off in a display from a selectable viewpoint. The first and third steps of obtaining a volume in digital form and displaying the volume are known to those skilled in the art. Accordingly, the description does not address in detail either the input or output steps other than in characterizing the relationship between the internal data description, volumetric error, and processing time.

In one embodiment, all volumes may be processed internally as binary-enumerated three dimensional arrays. In a binary-enumerated array of the present invention, each data point in the three dimensional arrays takes on either a first value or a second value, such as ones and zeros. For example, the interior of the volume may be represented by ones and any data points outside the volume may be represented by zeros or in the alternative. The data points have an associated coordinate that may be an x, y, z coordinate. Other coordinate systems might also be utilized—such as spherical or cylindrical coordinates.

In this format, the x, y, and z coordinates relate to real world positions. Thus, data points may be utilized in the coordinate system to describe an object, which is represented as a volume.

As another example of a binary-enumerated array format, at whatever points the object exists inside the coordinate system, the data value of those points are set to a value greater than zero. If the object does not exist at those points, then the data value is zero.

The largest source of error, for both input and output, is the spatial difference between the real world position represented by the array coordinate and the position of the actual object boundary in the vicinity of that coordinate. Increasing the coordinate array density, or the number of points, reduces the system error by a proportional amount.

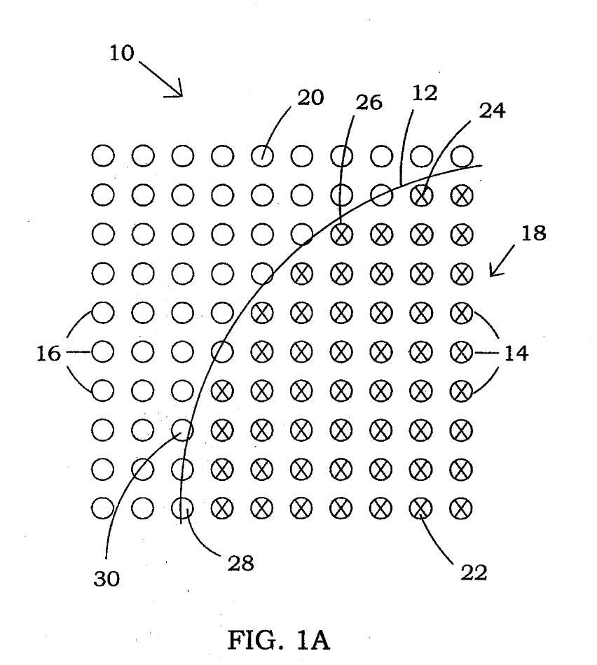

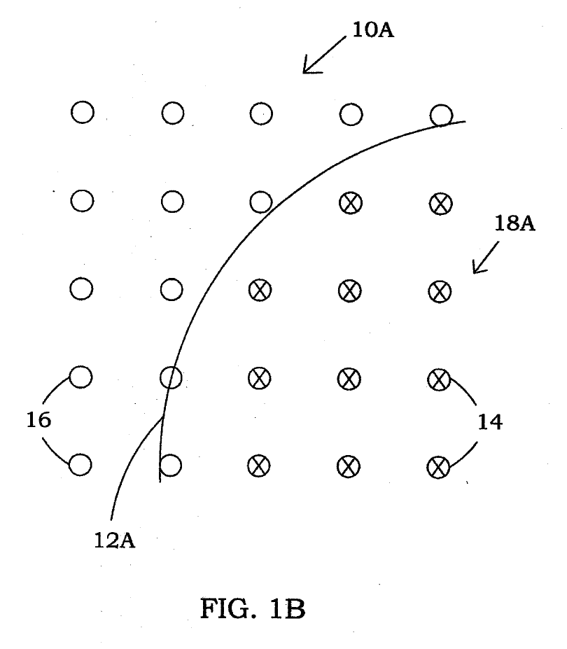

FIG. 1A and FIG. 1B illustrate one side of a volume whereby a simpler two dimensional example is viewed for binary-enumerated arrays 10 and 10A. In the binary-enumerated arrays 10 and 10A, data points 16 are exterior to volumes 18 and 18A. Points 14 are inside of the volumes 18 and 18A. Boundaries of surfaces 12 and 12A represent the dividing line or surface of the volumes 18 and 18A.

It will be readily appreciated that as the density of the volumes increases, or the more points that are in the array, the better defined the surface of the volume is. Thus, a greater density of data points may result in more accuracy with respect to the real world volume which is represented by the binary-enumerated array.

Once a volume is represented as a binary-enumerated array, the surface of the object may be extracted by evaluating each point in the array with respect to neighboring points. For example, referring to data point 20 in FIG. 1A, the data point and all neighbors of the data point are zero. Therefore, the data point 20 is determined by the method to be exterior to the volume 18 and is not evaluated as a surface point of the volume. Likewise, data point 22 and all neighbors of the data point 22 are greater than zero. Thus, the data point 22 is determined or defined by the method as being interior to the volume 18 and is ignored for purposes of evaluating the surface of the volume.

However, in those regions where the data is mixed, such as along the line which indicates the surface 12, the data points are defined as the surface of the volume. For example, the data points 24 and 26 are not the same as all of the neighboring points. Therefore, the data points 24 and 26 as well as other data points with dissimilar neighbors are considered to be on the surface of the volume.

In one embodiment, only data points which are inside of the volume are considered to be on the surface. However, in another embodiment, data points outside the volume but dissimilar with their neighbors may also be defined as being on the surface, e.g., data points 28 and 30.

In one embodiment, each data point defined as being on the surface of the volume is then evaluated. For example, the point may be categorized as being on a flat surface, on an edge bent in two dimensions, on a corner bent in three dimensions, on an arc, part of a curved surface, or otherwise classified.

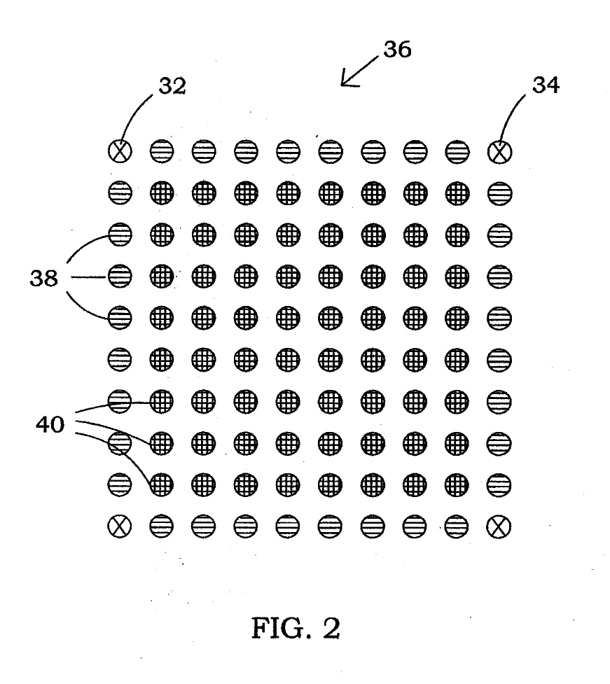

In FIG. 2, which shows one side of cubic volume 36, data points 32 and 34 are classified as corners which are bent in three dimensions. The classification is made by comparing the location of the neighboring data points with each point. In other words, the method will detect that the coordinates of neighboring surface data points vary in three dimensions. Similarly, data points 38 will be considered as being edges bent in two dimensions because the neighboring data points have coordinates that are positioned in two different directions. Data points 40 are classified as being on a flat surface because the neighboring data points lay in the same plane.

Separate lists are maintained for each type of data point. These lists can then be utilized for more quickly displaying the surfaces of interest. A volume whose surface has been categorized can then be stored for future use, expanded, or intersected.

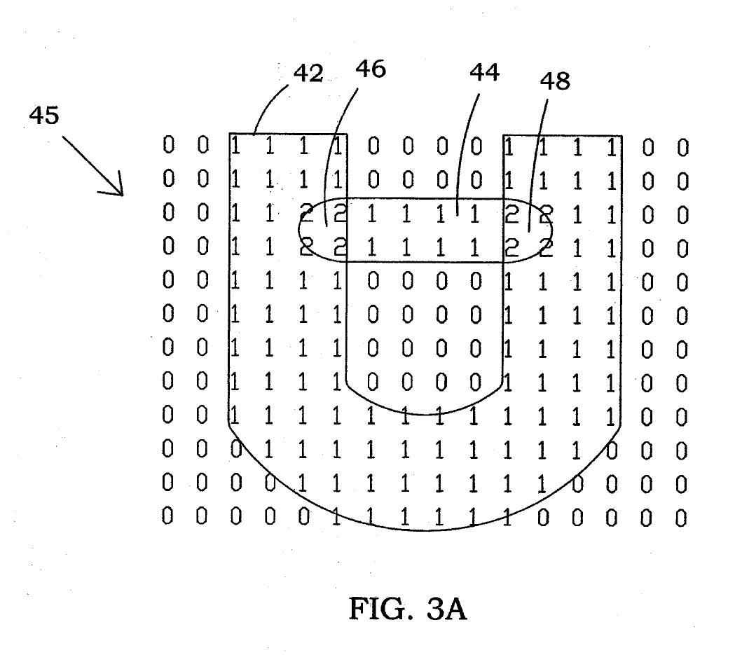

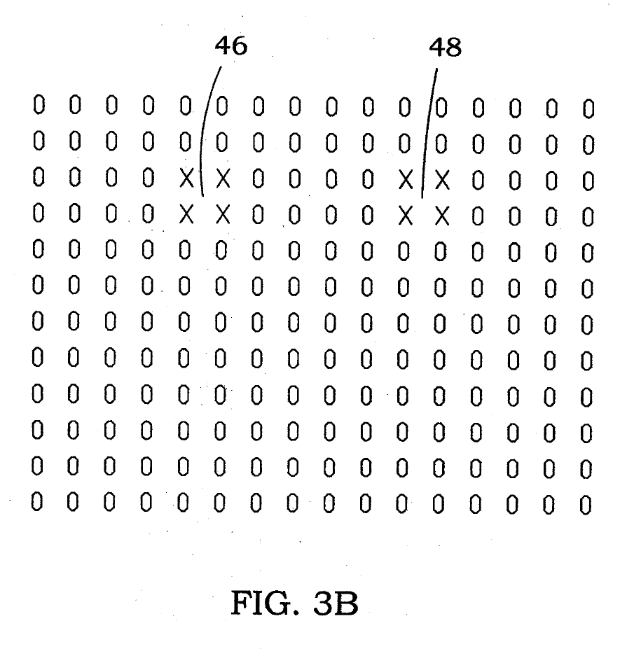

FIG. 3A and FIG. 3B illustrate a possible embodiment utilized to determine an intersection between two or more volumes. The offset between the two sets of real world coordinates (i.e., the coordinates of the binary enumerated volumes) is determined. When data points at the surface and interior are at the same x, y, z coordinate position, then their values are added.

In FIG. 3A, volumes 42 and 44 are within coordinate system 45. For simplicity, only one side of the three dimensional volumes is shown. Each volume 42 and 44 are binary-enumerated arrays with one's at positions internal to the volumes and zeros at positions external to the volumes. The volume 42 is U-shaped and the volume 44 is pill-shaped. Wherever one's are at the same coordinate, then they are added as shown to make two's at regions 46 and 48. Accordingly, the process may result in zero's at coordinates which are outside both volumes, and one's (or the base value) at coordinates which line in only one of the two source regions, and two's (or twice the base value) for regions which intersect.

The resultant intersected volume may then be normalized back to a simple enumerated volume and the surface evaluated and saved for future use. The intersections may then be treated as separate and distinct volumes. In the example of FIG. 3B, all values in the coordinate system set to either zero or one are reset to zero. The values in the regions 46 and 48 are then reset to ones or any other value which describes the value of the volume. In other words, for this embodiment of the invention, the regions 46 and 48 are transformed into binary-enumerated arrays. The data points along the surface are then classified as described hereinbefore and a list is made.

Expansion of a volume requires several more steps than creating an intersection volume. An expansion may be made at any portion of a volume or at a single point in a volume. The expansion may be isotropic or may be in any desired direction or directions.

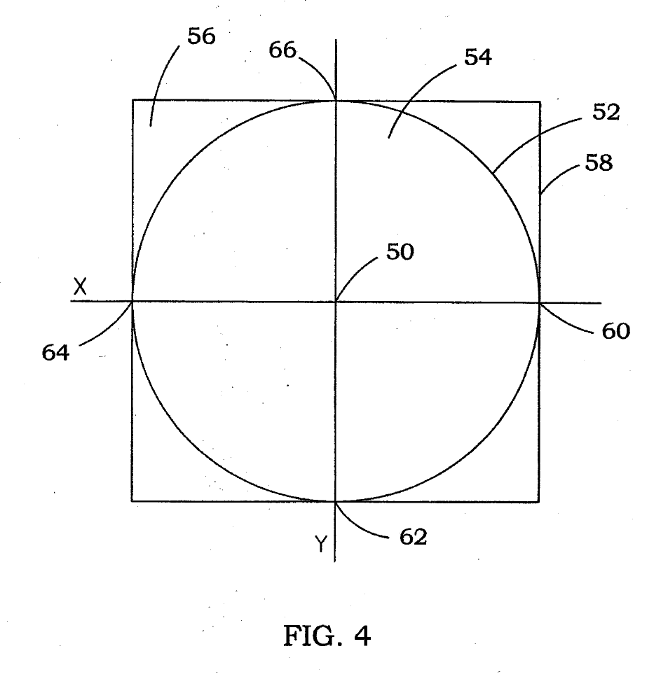

Consider FIG. 4, which illustrates an isotropic expansion around a single data point, such as data point 50. Because the expansion is isotropic, the expansion will appear spherical or circular in two dimensions as shown by circle 52. An enumerated volume may then be created so that any data points within the interior of sphere or the circle 52 are set to one. Data points outside of sphere or the circle 52 such as in region 56 remain zero. The surface points are then determined and categorized.

As discussed hereinbefore, various parameters may be utilized in categorizing surface data points. For a circular isotropic expansion, the six orthogonal surface coordinates lying along the x, y, z axis of a square template surrounding the expansion might be utilized. For example, if a coordinate system with x, y, and z coordinates were located with the origin at the data point 50, and a cube 58 were formed around the sphere 52, then data points at 60, 62, 64, and 66 are stored as orthogonal surface points. It will be appreciated that two additional orthogonal data points would be stored at the z axis intersections.

As another example, data points lying along the planes of the coordinate system may be recorded as arcs. For example, in the x, y plane, surface data points along the circle 52 may be categorized and recorded as arcs. Other data points may be categorized and recorded as spherical surfaces or quadrants.

A non-isotropic expansion can be constructed by use of a binary-enumerated volume or template whose dimension and internal data structure represent the scope of expansion in any given direction relative to the center reference point of the binary enumerated volume or template.

Thus, in one embodiment of the invention, a template used for expansion is itself a binary-enumerated three dimensional array. The surface of the template is then categorized. The template is then applied to the surface points of the original volume, which is to be expanded.

For example, if an isotropic expansion is desired, then a spherical template is created such as that shown in FIG. 4. All points inside the template may be set to ones and all points outside the template are set to zeros thereby creating a volume in binary-enumerated array format. Then the origin or center of the volume is effectively added to each point of the surface of the volume to be expanded. Then all non-zero points are set to one and the points outside remain zero. The new outer surface data points are determined and the surface data points are categorized.

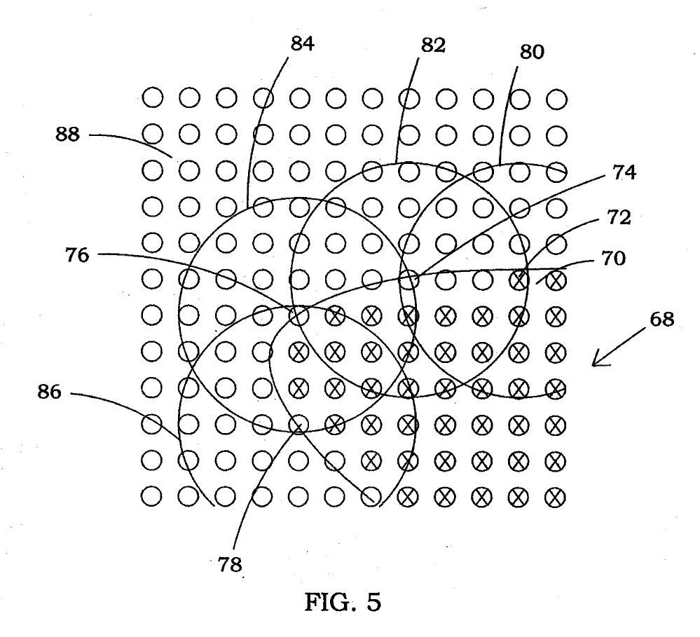

For example, referring to FIG. 5, one side of an original volume 68 is shown which has a surface along line 70. All data points inside original volume 68 are set to one. All points outside the original volume 68 are set to zero. An isotropic expansion is desired with a radius equal to the spacing of four data points. Thus, a sphere with a radius of four data points is created. This sphere is then added to each point on the surface of the original volume 68. Consider data points 72, 74, 76 and 78. It will be seen that corresponding spheres 80, 82, 84, and 86 (or circles in two-dimensions) surround each of the data points 72, 74, 76, and 78, respectively.

In actual practice, a sphere would surround each point defined as being on the surface of volume 68 but for simplicity only four spheres 80, 82, 84, and 86 are shown in this example. Moreover, even though the data points within the outline of the spheres 80, 82, 84, and 86 are ones, they are shown as zeros so that the original volume 68 is visible.

Once all the spheres are drawn, then everything inside those spheres including the interior of the volume 68 would eventually be set to one, assuming that one is the value for the interior of volumes. Everything outside both the spheres and the original volume 68 remains zero. This process may involve first adding all data points within the spheres to all points of the volume 68. Then, all non-zero points may be set to one.

To explain this in another way, first, a new enumerated volume is created which encompasses the original and sufficient space to account for the maximum possible expansion in any direction. Once this is done, the offset position of each point of the template is added to the position of every surface point of the original volume. The resulting offset is then mapped to the final enumerated volume. To reduce the number of points mapped and eliminate the mapping of points into the interior of the volume, only those template points, arcs, and quadrants are used which relate to the correct expansion given the character of the original surface. Thus, FIG. 5 shows two dimensions of an example of the mapping of points and arcs to the planer side of volume 68.

As another possibility, the spherical templates or volumes 80, 82, 84, 86 are applied to the data points 72, 74, 76, and 78 and additional spherical volumes or templates are applied to all other surface data points. The resultant volume is then processed as follows: First an exterior region 88, which is outside the spherical templates, is filled out by conducting a flood fill to a specific value such as zero. Then the data is inverted back into a binary-enumerated volume by resetting all non-outside points to the inside value, such as one. Lastly, the volume is processed to find the surface data points which are mapped into faces, edges and corners. The expanded volume is now independent of the source and template data and may be used for any processing technique suitable for an enumerated volume.

With respect to organization of a method in accordance with one embodiment of the present invention, implementation of the concept can be encapsulated into at least three C++ classes; Each class might consist or comprise a .cpp and a .h file.

The method in use or software compatible with the method of the present invention greatly speeds of the process of expanding models of three dimensional volumes and in computing the intersection region between different three dimensional volume models.

Many additional changes in the details, components, steps, and organization of the system, herein described and illustrated to explain the nature of the invention, may be made by those skilled in the art within the principle and scope of the invention. It is therefore understood that within the scope of the appended claims, the invention may be practiced otherwise than as specifically described.

What is claimed is:

1. A method for displaying intersections and expansions of three dimensional volumes wherein the three dimensional volumes represent physical phenomena which may vary in shape as time progresses, the method comprising the steps of:
representing at least one volume in a binary-enumerated three dimensional array format wherein all data points outside the at least one volume are set to a first value and all data points inside the at least one volume are set to a second value;
determining surface data points of the volume by comparing each data point with neighboring data points and selecting data points which have neighboring data points which differ in value as the surface data points;
classifying the surface data points with classifications wherein the classifications comprise at least one of corners bent in three dimensions, edges bent in two directions, flat surfaces, arcs, and rounded surfaces; storing at least one list of the classifications; and displaying the surface points.

2. The method of claim 1 further comprising the step of processing an intersection between at least two volumes wherein each volume is represented in the binary-enumerated three-dimensional array format, the processing step comprising:
creating a third value for intersecting data points which have the second value at same locations in a coordinate system;
setting data points which have the first value to the first value;
setting data points which have the second value to the first value;
setting data points with the third value to the second value whereby at least one intersection volume is formed in the binary-enumerated three dimensional array format;
determining and classifying surface data points for the at least one intersection volume with classifications wherein the classifications comprise at least one of corners bent in three dimensions, edges bent in two directions, flat surfaces, arcs, and rounded surfaces; and
storing at least one list of the classifications of the surface points for the at least one intersection volume.

3. The method of claim 1 further comprising:
expanding the at least one volume by applying a respective expansion volume to each selected surface data point of the at least one volume where expansion is to occur; and
setting data points which are inside each expansion volume and also within the at least one volume to the second value whereby at least one expanded volume is formed in the binary-enumerated three dimensional array format.

4. The method of claim 3 wherein an isotropic expansion is made by applying a spherical volume to a plurality of surface data points of the at least one volume where expansion is to occur.

5. The method of claim 3 wherein a non-isotropic expansion is made by applying a non-spherical volume to a plurality of surface data points of the at least one volume where expansion is to occur.

6. The method of claim 3 wherein the selected surface points correspond to a first portion of the at least one volume but not to a second portion whereby only the first portion of the at least one volume is expanded.

7. The method of claim 1 wherein the at least one volume represents a region inside of which there is a selected probability that a naval contact exists.

8. The method of claim 1 wherein the at least one volume represents a region of the atmosphere into which a gas has been injected which expands over time due at least in part to wind velocity, gas density, molecular weight, and entropy.
